(19) United States
(12) Patent Application Publication
(10) Pub. No.: US 2024/0005429 A1
(43) Pub. Date: Jan. 4, 2024

(54) COLLEGE MATCHING SYSTEM BASED ON HIERARCHICAL ACCEPTANCE RATE AND METHOD THEREOF

(71) Applicant: LETITU CO., LTD., Seongnam-si (KR)

(72) Inventor: Da Hun LEE, Seoul (KR)

(21) Appl. No.: 17/813,757

(22) Filed: Jul. 20, 2022

(30) Foreign Application Priority Data
Jun. 30, 2022 (KR) 10-2022-0080183

(51) Int. Cl. G06Q 50/20

(52) U.S. Cl. CPC G06Q 50/2053

(57) ABSTRACT

An embodiment of the present invention provides a college matching system comprising: a user interface for inputting college admission basic data of a user. The system receives and stores the input college admission basic data of the user; generates an acceptance rate calculation parameter to be applied to an acceptance rate calculation algorithm of each college based on a first basic data corresponding to acceptance statistics of each college and a second basic data corresponding to data on successful applicants of each college; calculates an acceptance rate by applying a weight to the college admission basic data and using the acceptance rate calculation algorithm to which the generated acceptance rate calculation parameter and the weight is applied; classifies the calculated acceptance rate into a hierarchy according to a preset condition; and provides data on the acceptance rate classified into a hierarchy and information on colleges corresponding thereto.

### CROSS-REFERENCE TO RELATED APPLICATION

This application claims priority under 35 U.S.C. § 119 to Korean Patent Application No. 10-2022-0080183 filed in the Korean Intellectual Property Office on Jun. 30, 2022, the entire contents of which is hereby incorporated by reference.

### FIELD OF THE INVENTION

The present invention relates to a college matching system based on a hierarchical acceptance rate and a method thereof, and more particularly, to a college matching system and a method thereof, which can provide a user with structured acceptance rates of innumerable colleges by generating acceptance rate calculation parameters reflecting college admission processes different for each college, calculating accurate acceptance rates of corresponding colleges by matching the generated acceptance rate calculation parameters based on user data, and classifying the calculated acceptance rates into a hierarchy.

### BACKGROUND OF THE RELATED ART

There are about 4,000 universities in the United States, and documents required by each department or a college admission process thereof are different. Students who desire to enter the universities in the United States have difficulty in objectively and accurately grasping information on the many universities. In addition, monitoring the admissions procedures of each college updated every time requires a considerable time. Moreover, the process of students for filtering universities, in which their GPA, SAT, ACT and/or extracurricular activities are advantageously reflected, is quite complicated. In addition, it is practically impossible for the students to additionally consider by themselves their preferred conditions such as a region of school and tuition fee of the universities.

On the other hand, conventionally, in order to solve such problems, the students confirm the college admission process and prepare the documents of each college with the help of offline college admission consulting companies. However, there is a limit in that the number of students that can be managed by the college admission consulting companies is limited. In addition, the accuracy may be somewhat low since the consulting is conducted based on subjective opinions of admission consulting experts and constructed databases.

Therefore, for the students who desire to enter the universities in the United States, it needs to provide a college matching technique for filtering universities by reflecting additional factors, and objectively calculating an acceptance rate of each college based on college admission data.

### SUMMARY OF THE INVENTION

Therefore, the present invention has been made in view of the above problems, and it is an object of the present invention to provide a college matching system and a method thereof, which can generate acceptance rate calculation parameters reflecting college admission processes different for each college, and calculate accurate acceptance rates of corresponding colleges by matching the acceptance rate calculation parameters based on college admission basic data of a user.

In addition, another object of the present invention is to provide a college matching system and a method thereof, which can match colleges by reflecting additional conditions such as the regions of school preferred by the user, tuition fees, and the like.

In addition, another object of the present invention is to provide a college matching system and a method thereof, which can calculate an acceptance rate more accurately by generating acceptance rate calculation parameters based on the data provided by each college and correcting the acceptance rate calculation parameters based on the data of students admitted to the college.

In addition, another object of the present invention is to provide a college matching system and a method thereof, which allows a user to efficiently confirm information on a matching college by classifying the calculated acceptance rates into a hierarchy according to a preset condition.

The technical problems to be solved by the present invention are not limited to the technical problems mentioned above, and unmentioned other technical problems can be clearly understood by those skilled in the art from the following description.

To accomplish the above objects, according to one aspect of the present invention, there is provided a college matching system comprising: a user interface for inputting college admission basic data of a user; a college admission basic data receiving unit for receiving and storing the input college admission basic data of the user; an acceptance rate calculation parameter generation unit for generating an acceptance rate calculation parameter to be applied to an acceptance rate calculation algorithm of each college based on a first basic data corresponding to acceptance statistics of each college and a second basic data corresponding to data on successful applicants of each college; an acceptance rate calculation engine for calculating an acceptance rate by applying a weight to the college admission basic data and using the acceptance rate calculation algorithm to which the generated acceptance rate calculation parameter and the weight is applied;

an acceptance rate hierarchy generation unit for classifying the calculated acceptance rate into a hierarchy according to a preset condition; and a hierarchical acceptance rate data output unit for providing data on the acceptance rate classified into a hierarchy and information on colleges corresponding thereto.

The acceptance rate calculation engine may include: a college admission basic data analysis unit for analyzing the college admission basic data of the user; an acceptance rate calculation parameter search unit for searching for the acceptance rate calculation parameter based on the analyzed college admission basic data of the user; a user information weight application unit for assigning a weight according to a predetermined condition to the college admission basic data of the user; a rank information application unit for applying rank information of the college to the acceptance rate calculation parameter based on the first basic data; and an acceptance rate calculation unit for calculating the acceptance rate by setting the weighted college admission basic data as a variable and setting the acceptance rate calculation parameter as a coefficient in the acceptance rate calculation algorithm.

In an embodiment of the present invention, the college matching system may further comprise a data processing unit for extracting and processing only necessary data from the first basic data and the second basic data, and the data processing unit may extract and process at least one among a college ID, a GPA score, a SAT/ACT distribution, an acceptance rate, and a rank from the first basic data, and extract and process at least one among a college ID, a GPA score, a SAT/ACT score, a major, and an extracurricular activity from the second basic data.

The data processing unit may supplement the first basic data using the second basic data.

The college matching system may further comprise a sub-data matching unit for matching sub-data to the acceptance rate calculated based on the college ID of the first basic data.

The college matching system may further comprise a hierarchical acceptance rate data output unit for outputting at least one piece of information for each of a reach school, a target school, and a safety school according to the acceptance rate classified into a hierarchy.

To accomplish the above objects, according to another aspect of the present invention, there is provided a method of matching a college based on a hierarchical acceptance rate by a college matching system connected to a user terminal through a network, the method comprising the steps of: a) securing college admission basic data of a user by providing an input interface to the user terminal, by the college matching system; b) analyzing the college admission basic data of the user, by the college matching system; c) searching for an acceptance rate calculation parameter based on the analyzed college admission basic data of the user, by the college matching system; d) applying a weight to the college admission basic data of the user, by the college matching system; e) calculating an acceptance rate using the acceptance rate calculation parameter and an acceptance rate calculation algorithm to which the weighted college admission basic data is applied, by the college matching system; and f) classifying the calculated acceptance rate into a hierarchy according to a preset condition, and outputting the acceptance rate together with a matching college, wherein the acceptance rate calculation parameter is generated based on a first basic data corresponding to acceptance statistics of each college and a second basic data corresponding to data on successful applicants of each college.

The acceptance rate calculation parameter may be generated by supplementing the first basic data using the second basic data.

The college admission basic data of the user may include at least one among a grade level, a region of school, a major, a tuition fee, a SAT/ACT score, and a GPA score.

Step f) may include the step of outputting at least one piece of information for each of a reach school, a target school, and a safety school according to the acceptance rate classified into a hierarchy.

The college matching method may further comprise the step of displaying at least one additional college for each of the reach school, the target school, and the safety school in descending order or ascending order of the acceptance rate.

### BRIEF DESCRIPTION OF THE DRAWINGS

FIG. 1 is a view showing the configuration of a college matching system according to an embodiment of the present invention.

FIG. 2 is a view showing a detailed configuration of a college matching system according to an embodiment of the present invention.

FIG. 3 is a view showing a process of calculating an acceptance rate by generating acceptance rate calculation parameters according to an embodiment of the present invention.

FIG. 4 is a block diagram showing a detailed configuration of an acceptance rate calculation engine according to an embodiment of the present invention.

FIG. 5 is a flowchart illustrating a process of calculating and outputting an acceptance rate according to an embodiment of the present invention.

FIG. 6 is a flowchart illustrating a process of inputting college admission basic data of a user through a user input interface according to an embodiment of the present invention.

FIG. 7 is a view showing a matched college displayed on a user terminal according to an embodiment of the present invention.

### DETAILED DESCRIPTION OF THE PREFERRED EMBODIMENT

Hereinafter, the present invention will be described with reference to the accompanying drawings. However, the present invention may be implemented in several different forms, and thus is not limited to the embodiments described herein. In addition, in order to clearly explain the present invention in the drawings, parts unrelated to the description are omitted, and similar reference numerals are attached to similar parts throughout the specification.

Throughout the specification, when a part is “linked (connected, contacted, coupled)” to another part, it includes the cases of being “indirectly connected” with intervention of another member therebetween, as well as the cases of being “directly connected”. In addition, when a part “includes” a certain component, this means that other components may be further provided rather than excluding other components unless clearly stated otherwise.

The terms used in this specification are used only to describe specific embodiments, and are not intended to limit the present invention. Singular expressions include plural expressions unless the context clearly dictates otherwise. It should be understood that in the present specification, terms such as “comprise” or “have” are intended to specify existence of a feature, number, step, operation, component, part, or combination thereof described in the specification, not to preclude the possibility of existence or addition of one or more other features, numbers, steps, operations, components, parts, or combinations thereof.

In this specification, a “module” includes a unit configured of hardware, software, or firmware, and for example, may be used interchangeably with terms such as logic, logic block, component, or circuit. The module may be an integrally configured component, a minimum unit performing one or more functions, or a part thereof. For example, the module may be configured as an application-specific integrated circuit (ASIC).

Hereinafter, embodiments of the present invention will be described in detail with reference to the accompanying drawings.

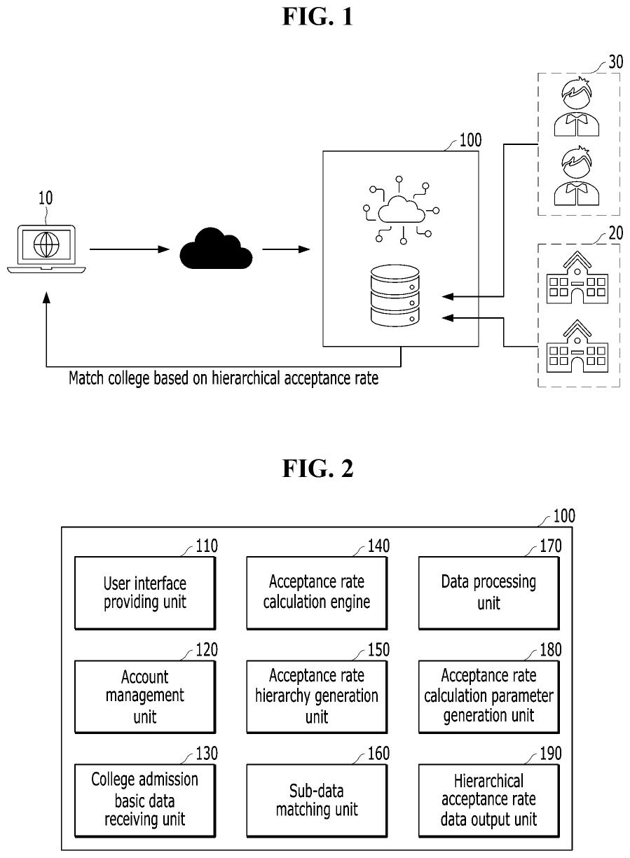

FIG. 1 is a view showing the configuration of a college matching system according to an embodiment of the present invention.

Referring to FIG. 1, a college matching system 100 may provide an input interface to the user terminal 10 to secure college admission basic data of a user. For example, the user may input college admission basic data of the user, such as a grade level, a region of school, a major, a tuition fee, a SAT/ACT score, a GPA score, and the like, using the user terminal 10. The user terminal 10 may include a PC, a desktop computer, a smart phone, a tablet computer, and the like.

In addition, the college matching system 100 may receive and store a first basic data and a second basic data. For example, the first basic data may include GPA scores, SAT/ACT distributions, acceptance rates, and the like of successful applicants provided by the college. That is, the first basic data may be statistics of admission data provided by each college. Accordingly, the college matching system 100 may utilize accurate information by reflecting the college admission process of each college in real-time.

In addition, the second basic data may include an actual GPA/SAT/ACT score and the like, which are acceptance data of individual students admitted to each college. Although the second basic data may be generated from a small number of samples compared to the first basic data, it may include more pieces of additional information than the first basic data.

The college matching system 100 may process the stored first basic data and second basic data. First, it may process the first basic data into a college ID, a GPA score, a SAT/ACT distribution, an acceptance rate, a rank, and the like. In addition, it may process the second basic data into a college ID, GPA score, SAT/ACT score, major, extracurricular activity, and the like.

The college matching system 100 may generate acceptance rate calculation parameters based on the processed first basic data. At this point, the college matching system 100 may generate the acceptance rate calculation parameters for each college ID. In addition, the college matching system 100 may supplement the generated acceptance rate calculation parameters based on the second basic data. Accordingly, the college matching system 100 may reflect actual acceptance data of students in calculating the acceptance rate.

In addition, the college matching system 100 may calculate an acceptance rate using an acceptance rate calculation engine. Here, the college matching system 100 may set a weight based on the college admission basic data. Accordingly, the college matching system 100 may calculate an acceptance rate customized to the user. In addition, the college matching system 100 may output the calculated acceptance rate in a hierarchy. For example, the college matching system 100 may classify the acceptance rate into a hierarchy of a reach school, a target school, and a safety school according to a preset condition. That is, the college matching system 100 may subdivide and output acceptance rates of a plurality of colleges by classifying the acceptance rates into a hierarchy.

FIG. 2 is a view showing a detailed configuration of a college matching system according to an embodiment of the present invention.

The college matching system 100 includes a user interface providing unit 110, an account management unit 120, a college admission basic data receiving unit 130, an acceptance rate calculation engine 140, an acceptance rate hierarchy generation unit 150, and a sub-data matching unit 160, a data processing unit 170, an acceptance rate calculation parameter generation unit 180, and a hierarchical acceptance rate data output unit 190.

The user interface providing unit 110 may provide a user interface for inputting college admission basic data of a user. For example, the college admission basic data of a user may include the grade level, region of school, major, tuition fee, SAT/ACT score, GPA score, and the like of the user.

The account management unit 120 may generate and manage a user account. The user account may be in the form of an ID or a password, and used for managing login information, authentication information, and the like of the generated account.

In addition, the college admission basic data receiving unit 130 may receive and store college admission basic data of the user input through the user interface.

The acceptance rate calculation engine 140 may calculate an acceptance rate of the user to a college. The acceptance rate calculation engine 140 receives a plurality of information, which is college admission basic data, as an input, and calculates an acceptance rate in a range of to 100% using the acceptance rate calculation parameters for each college generated from the processed first basic data and second basic data.

For example, the first basic data may include GPA scores, SAT/ACT distributions, acceptance rates, and the like of successful applicants provided by a college. In addition, the second basic data may include an actual GPA/SAT/ACT score and the like, which are acceptance data of individual students.

The acceptance rate calculation engine 140 may generate a formula for calculating an acceptance rate for each college, and the acceptance rate calculation parameters may be set as a coefficient of each formula.

In addition, the acceptance rate calculation engine 140 may apply a weight to the college admission basic data of the user used for calculating the acceptance rate. The applied weight may be set as a variable of the acceptance rate calculation formula. When a specific field of the college admission basic data has no information or is 0, a weight may be assigned to the college admission basic data in consideration of the grade level included in the college admission basic data, extracurricular items not included in the acceptance rate calculation formula, and the like.

In addition, the acceptance rate calculation engine 140 may apply rank information based on the first basic data. For example, the higher the rank of a college is, the smaller the weight assigned the acceptance rate calculation engine 140. That is, the acceptance rate calculation engine 140 may assign a weight according to the rank of a college.

The acceptance rate calculation engine 140 may output an acceptance rate by inputting the college admission basic data of the user into an acceptance rate calculation algorithm. The acceptance rate calculation engine 140 may calculate an acceptance rate of a college corresponding to each acceptance rate calculation parameter.

The acceptance rate hierarchy generation unit 150 may classify the calculated acceptance rate into a hierarchy. In order to classify the calculated acceptance rate into a hierarchy in an embodiment of the present invention, a predetermined acceptance rate is designated as an acceptance rate corresponding to a reach school, a target school, or a safety school for a specific user. Colleges corresponding to the acceptance rates of a reach school, a target school, and a safety school may be classified into a hierarchy in descending order or ascending order.

That is, the acceptance rate hierarchy generation unit 150 may subdivide the acceptance rates of a plurality of colleges by classifying the acceptance rates into a hierarchy, and hierarchically display the acceptance rates to the user.

The sub-data matching unit 160 may match sub-data of a college with the acceptance rate. The sub-data may include a college name, a region, a tuition fee, A SAT/ACT distribution, a GPA score, and the like. That is, the sub-data matching unit 160 may match additional information of a college corresponding to the calculated acceptance rate. For example, the sub-data matching unit 160 may match the sub-data based on the college ID that is used when the acceptance rate is calculated.

The data processing unit 170 may process the first basic data and the second basic data. For example, the first basic data and the second basic data may be received in various ways according to the form of each college or individual student. Accordingly, the data processing unit 170 may extract only necessary data from the first basic data and the second basic data. The data processing unit 170 may extract and classify the college ID, GPA score, SAT/ACT distribution, acceptance rate, rank, and the like from the first basic data. In addition, the data processing unit 170 may classify the second basic data into a college ID, a GPA score, a SAT/ACT score, a major, an extracurricular activity, and the like.

The acceptance rate calculation parameter generation unit 180 may generate acceptance rate calculation parameters based on the first basic data. At this point, the acceptance rate calculation parameter generation unit 180 may generate the acceptance rate calculation parameters for each college. That is, the acceptance rate calculation parameter generation unit 180 may reflect a different college admission process according to colleges. For example, the acceptance rate calculation parameter generation unit 180 may assign a high coefficient to an extracurricular activity parameter when the proportion of an extracurricular activity is high. Accordingly, as the acceptance rate calculation parameter generation unit 180 may generate the acceptance rate calculation parameters by reflecting admission criteria different for each college, the acceptance rate calculation engine 140 may calculate the acceptance rate more accurately.

The hierarchical acceptance rate data output unit 190 may output acceptance rate data classified into a hierarchy. For example, the hierarchical acceptance rate data output unit 190 may output acceptance rate data corresponding to a reach school, a target school, and a safety school. In addition, the hierarchical acceptance rate data output unit 190 may output sub-data matched to the hierarchical acceptance rate data. That is, the hierarchical acceptance rate data output unit 190 may output hierarchical acceptance rate data, corresponding college name, location, tuition fee, SAT/ACT distribution, and the like.

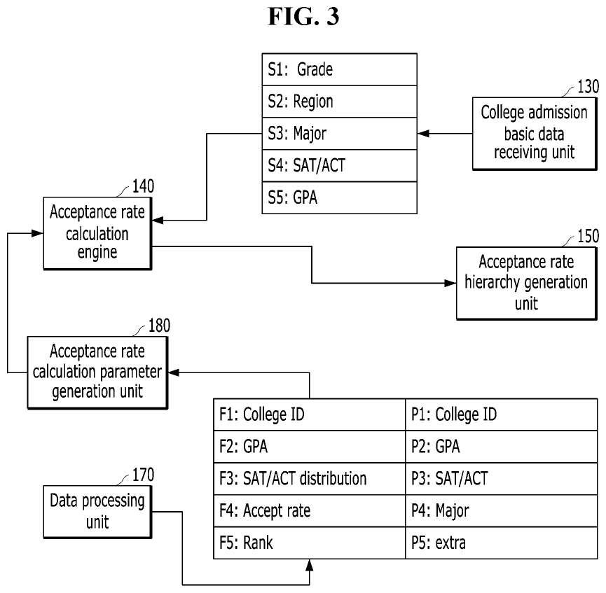

FIG. 3 is a view showing a process of calculating an acceptance rate by generating acceptance rate calculation parameters according to an embodiment of the present invention.

First, the data processing unit 170 may process the first basic data and the second basic data. The data processing unit 170 may extract only necessary data from the first basic data and the second basic data. The data processing unit 170 may extract College ID (F1), GPA (F2), SAT/ACT distribution (F3), Accept rate (F4), Rank (F5), and the like from the first basic data and classify the extracted data. In addition, the data processing unit 170 may classify the second basic data into College ID (P1), GPA (P2), SAT/ACT (P3), Major (P4), Extra (P5), and the like.

The acceptance rate calculation parameter generation unit 180 may generate acceptance rate calculation parameters based on the processed first basic data. At this point, the acceptance rate calculation parameter generation unit 180 may generate an acceptance rate calculation parameter for each College ID (F1) of the first basic data. That is, the acceptance rate calculation parameter generation unit 180 may generate an acceptance rate calculation parameter by reflecting college admission processes different for each college. For example, the acceptance rate calculation parameter generation unit 180 may set the acceptance rate calculation parameter of the College ID (F1) as a coefficient of the acceptance rate calculation formula.

In addition, the acceptance rate calculation parameter generation unit 180 may supplement the generated acceptance rate calculation parameters based on the second basic data. The acceptance rate calculation parameter generation unit 180 may supplement the acceptance rate calculation parameter of the College ID (F1) of the first basic data corresponding to the College ID (P1) of the second basic data. That is, the acceptance rate calculation parameter generation unit 180 may generate acceptance rate calculation parameters capable of calculating an accurate acceptance rate by reflecting information on actually admitted students in the information provided by the college.

In addition, the college admission basic data receiving unit 130 may receive college admission basic data of the user. The college admission basic data of the user may include Grade (S1), Region (S2), Major (S3), SAT/ACT (S4), and GPA (S5). In addition, the college admission basic data may further include data related to a range of tuition fee that can be paid by the user. The college admission basic data receiving unit 130 may provide the college admission basic data of the user to the acceptance rate calculation engine 140.

Meanwhile, the acceptance rate calculation engine 140 may calculate an acceptance rate using the college admission basic data and the acceptance rate calculation parameters.

On the other hand, the acceptance rate calculation engine 140 may analyze the received college admission basic data of the user. In addition, the acceptance rate calculation engine 140 may search for a college appropriate to a corresponding region or tuition fee according to the result of analyzing the college admission basic data of the user. For example, the acceptance rate calculation engine 140 may search for an ID of a college located in Region (S2) of the college admission basic data of the user.

The acceptance rate calculation engine 140 may assign a weight to the college admission basic data of the user as a variable to be applied to the acceptance rate calculation parameters. For example, when a specific field of the college admission basic data has no information or is 0, the acceptance rate calculation engine 140 may assign a weight to the college admission basic data in consideration of the grade level included in the college admission basic data, extracurricular items not included in the acceptance rate calculation formula, and the like.

In addition, the acceptance rate calculation engine 140 may apply Rank (F5). For example, the acceptance rate calculation engine 140 may assign a low weight to the acceptance rate calculation parameters of a college corresponding to upper Rank (F5). Accordingly, the acceptance rate calculation engine 140 may calculate an acceptance rate based on the college admission basic data of the user, the first basic data, and the second basic data.

In addition, the acceptance rate hierarchy generation unit 150 may classify the calculated acceptance rates into a hierarchy. For example, the acceptance rate hierarchy generation unit 150 may classify the calculated acceptance rates into a hierarchy to correspond to a reach school, a target school, and a safety school according to a preset condition. That is, the acceptance rate hierarchy generation unit 150 classifies colleges into a reach school, a target school, and a safety school corresponding to the hierarchical acceptance rates. Here, the colleges corresponding to the acceptance rates of a reach school, a target school, and a safety school may be classified into a hierarchy in descending order or ascending order.

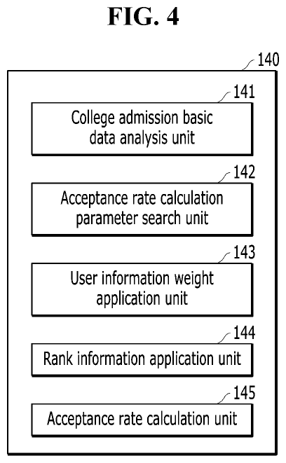

FIG. 4 is a block diagram showing a detailed configuration of an acceptance rate calculation engine according to an embodiment of the present invention.

As shown in FIG. 4, the acceptance rate calculation engine 140 may include a college admission basic data analysis unit 141, an acceptance rate calculation parameter search unit 142, a user information weight application unit 143, a rank information application unit 144, and an acceptance rate calculation unit 145.

The college admission basic data analysis unit 141 may analyze the college admission basic data of the user. Through the analysis on the college admission basic data, the grade level, region of school, GPA, SAT/ACT, preferred major, and the like of the user may be classified and stored. The classified and stored college admission basic data may be used as a basis for whether or not to apply a weight.

The acceptance rate calculation parameter search unit 142 may search for acceptance rate calculation parameters based on the analyzed college admission basic data of the user. For example, the acceptance rate calculation parameter search unit 142 may search for acceptance rate calculation parameters of all colleges located in a corresponding region by using Region (location) information of the college admission basic data of the user. The searched acceptance rate calculation parameters may be set as a coefficient of an acceptance rate calculation algorithm of each college.

The user information weight application unit 143 may assign a weight to the college admission basic data of the user. The weighted college admission basic data may be set as a variable of the acceptance rate calculation algorithm of each college.

The rank information application unit 144 may apply Rank information of the first basic data to the acceptance rate calculation parameters. For example, the rank information application unit 144 may apply a low weight or a low coefficient to an acceptance rate calculation parameter of a college in the top ranks. That is, the rank information application unit 144 may correct an acceptance rate error by applying rank information of a college to the acceptance rate calculation parameter.

The acceptance rate calculation unit 145 may calculate an acceptance rate using the college admission basic data of the user as an input of the acceptance rate calculation algorithm. The acceptance rate calculation algorithm may calculate an acceptance rate based on the acceptance rate calculation parameters. In addition, the acceptance rate calculation unit 145 may calculate an acceptance rate for each acceptance rate parameter.

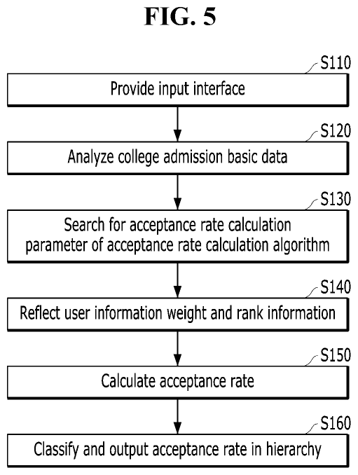

FIG. 5 is a flowchart illustrating a process of calculating and outputting an acceptance rate according to an embodiment of the present invention.

At step S110, the college matching system may provide an input interface to the user terminal. By providing the input interface, the college matching system may secure college admission basic data of a user. For example, the college admission basic data of a user may include the grade level, region of school, major, tuition fee, SAT/ACT score, GPA score, and the like of the user.

At step S120, the college matching system may analyze the input college admission basic data of a user.

Through the analysis on the college admission basic data, the grade level, region of school, GPA, SAT/ACT, preferred major, and the like of the user may be classified and stored. The classified and stored college admission basic data may be used as a basis for whether or not to apply a weight.

At step S130, the college matching system may search for acceptance rate calculation parameters of the acceptance rate calculation algorithm. Here, the acceptance rate calculation parameters may be generated based on the first basic data provided by a college. The first basic data may include GPA scores, SAT/ACT distributions, and acceptance rates of successful applicants provided by the college. In addition, the generated acceptance rate calculation parameters may be supplemented based on the second basic data. The second basic data may include a GPA/SAT/ACT score or the like, which is actual acceptance data of individual students.

That is, the college matching system may generate the acceptance rate calculation parameters by reflecting admission criteria different for each college, and supplement the acceptance rate calculation parameters based on actual acceptance data. Accordingly, the college matching system may provide a highly accurate acceptance rate by using the acceptance rate calculation parameters.

At step S140, the college matching system may set a user information weight for the acceptance rate calculation parameters based on the college admission basic data of the user.

The weighted college admission basic data may be set as a variable of the acceptance rate calculation algorithm of each college.

In addition, the college matching system may reflect college rank information in the acceptance rate calculation parameters based on the first basic data. The college matching system may make up for the acceptance rate error by reflecting the college rank information in the acceptance rate calculation parameters. For example, the college matching system may reduce the acceptance rate error by securing a relatively wide range of acceptance rate by applying a low weight or coefficient to a college to which a high rank is assigned.

At step S150, the college matching system may calculate the acceptance rate using the acceptance rate calculation parameters of the acceptance rate calculation algorithm. Here, the college matching system may input the college admission basic data of the user into the acceptance rate calculation algorithm.

At step S160, the college matching system may classify the calculated acceptance rate into a hierarchy. For example, the college matching system may classify the acceptance rate into a hierarchy of a reach school, a target school, and a safety school according to a preset condition. That is, the college matching system may classify the acceptance rate according to a predetermined range. The college matching system may subdivide acceptance rates of a plurality of colleges by classifying the acceptance rates into a hierarchy. In addition, the college matching system may sort and output the acceptance rates classified into a hierarchy in order of high acceptance rate. In addition, the college matching system may match and output sub-data of a corresponding college. The sub-data may include a college name, a region, a tuition fee, A SAT/ACT distribution, a GPA score, and the like. The college matching system may match the sub-data based on the College ID used when the acceptance rate is calculated. Accordingly, the user may easily understand necessary information.

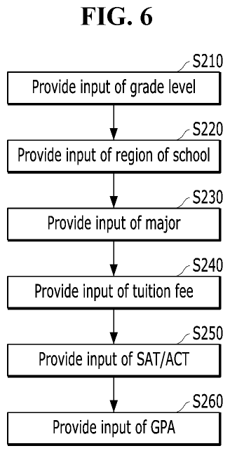

FIG. 6 is a flowchart illustrating a process of inputting college admission basic data of a user through a user input interface according to an embodiment of the present invention.

At step S210, the college matching system may provide an input of a grade level to the user terminal.

At step S220, the college matching system may provide an input of a region of school to the user terminal. For example, the college matching system may search for acceptance rate calculation parameters corresponding to the college ID based on the input region of school.

At step S230, the college matching system may provide an input of a major to the user terminal. For example, the college matching system may filter the searched acceptance rate calculation parameters based on the input major.

At step S240, the college matching system may provide an input of a tuition fee to the user terminal. For example, the college matching system may filter the searched acceptance rate calculation parameters based on the input tuition fee.

At step S250, the college matching system may provide an input of a SAT/ACT score to the user terminal.

At step S260, the college matching system may provide an input of a GPA score to the user terminal. The Grade Point Average (GPA) is academic records of high schools in the United States. As the GPA varies greatly according to the level and system of each high school, it is determined based on a percentage.

That is, the college matching system may calculate an acceptance rate using the input grade level, SAT/ACT score, and GPA score as variables of the acceptance rate calculation algorithm. Here, it has already been described that a weight may be assigned to the college admission basic data.

It will be apparent to those skilled in the art that the order of steps S210 to S260 may be changed according to a design of the user input interface.

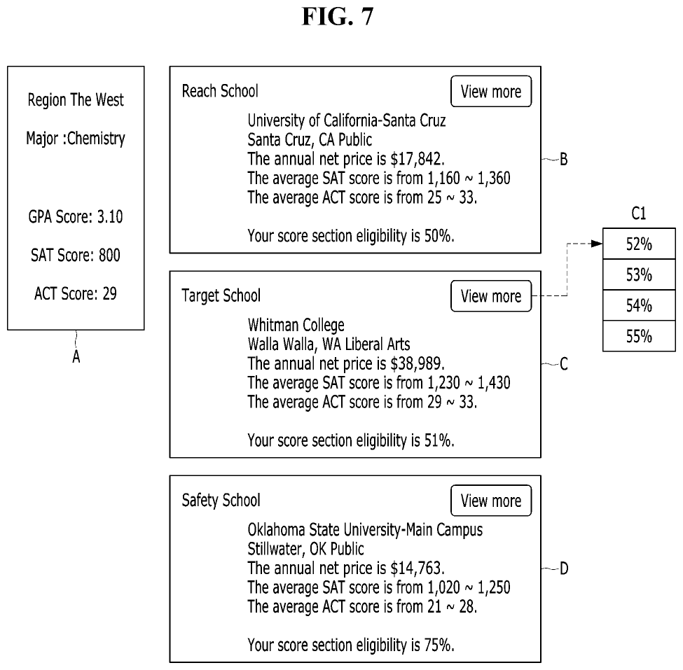

FIG. 7 is a view showing that matched colleges are displayed on a user terminal based on the acceptance rates classified into a hierarchy according to an embodiment of the present invention.

Based on the acceptance rates classified into a hierarchy, the college matching system 100 classifies the matched colleges into a reach school, a target school, and a safety school, and displays related information to the user terminal 10.

The college admission basic data (A) of a user may be displayed on one side of the display screen. Region, Major, GPA Score, SAT Score, and ACT Score may be displayed as the college admission basic data (A).

For example, the college matching system may set a college corresponding to less than 50% of the calculated acceptance rate as a reach school (B), and a college corresponding to 51% or more and less than 75% as a target school (C), and a college corresponding from 75% to 100% as a safety school (D).

In addition, the college matching system may match sub-data corresponding to the calculated acceptance rate. The sub-data may include a college name, a region, a tuition fee, A SAT/ACT distribution, a GPA score, and the like.

In addition, the college matching system may additionally provide more matching results classified into a hierarchy according to the calculated acceptance rate. For example, the college matching system may provide matching results of more colleges corresponding to the acceptance rates classified into a hierarchy using the “View More” interface. For example, the college matching system may provide the acceptance rates (C1) of a plurality of colleges matched as a target school (C). Although C1 is shown in a simplified form, a plurality of colleges matched as a target school (for example, of an acceptance rate of 52 to 74%) may be displayed together with college information and sub-data.

According to the configuration as described above, the college matching system according to the present invention may classify data of matched colleges, among a large number of colleges, into reach, target, and safety schools based on college admission basic data of a user, and provide the colleges in a hierarchical structure. Accordingly, the user may hierarchically acquire information on a target college and establish a plan for entering the college.

According to an embodiment of the present invention, parameters for calculating an acceptance rate of each college may be generated by reflecting a college admission process updated in real-time. In addition, coefficients or weights of the acceptance rate calculation parameters may be set as the acceptance rate calculation parameters according to college admission processes different for each college.

In addition, according to an embodiment of the present invention, since the generated acceptance rate calculation parameters are corrected based on actual data of successful applicants, an acceptance rate of high accuracy can be calculated.

In addition, according to an embodiment of the present invention, additional factors included in the college admission basic data of a user may be reflected. Accordingly, only the data required by the user may be effectively provided.

In addition, according to an embodiment of the present invention, the acceptance rates of a plurality of matched colleges may be subdivided by classifying the calculated acceptance rates into a hierarchy according to a preset condition. In addition, the acceptance rates classified into a hierarchy may be sorted and output in order of high acceptance rate. Accordingly, a user may intuitively confirm the acceptance rates of the matched colleges.

It should be understood that the effects of the present invention are not limited to the effects described above, and include all effects that can be inferred from the configuration of the invention described in the detailed description or claims of the present invention.

The method according to an embodiment of the present invention described above may be implemented in the form of program instructions that can be executed through various computer components, and recorded in a computer-readable recording medium. The computer-readable recording medium may include program instructions, data files, data structures, and the like alone or in combination. The program instructions recorded in the computer-readable recording medium may be specially designed and configured for the embodiments of the present invention, or may be known and available to those skilled in the art of computer software field. The computer-readable recording medium includes hardware configured to store and execute program instructions, such as a magnetic recording medium including a hard disk, a floppy disk, and a magnetic tape, an optical recording medium including a CD-ROM and a DVD, a magneto-optical medium including a floptical disk, ROM, RAM, flash memory, and the like. The program instructions include machine codes generated by a compiler, and high-level language codes that can be executed in a computer using an interpreter. The hardware may be configured to operate by one or more software modules to process the method according to the present invention, and vice versa.

The method according to an embodiment of the present invention may be executed in an electronic device in the form of a program instruction. The electronic device includes a portable communication device such as a smart phone, a smart pad or the like, a computer device, a portable multimedia device, a portable medical device, a camera, a wearable device, and a home appliance device.

The method according to an embodiment of the present invention may be provided to be included in a computer program product. The computer program product is a merchandise and may be traded between sellers and buyers. The computer program product may be distributed in the form of a device-readable recording medium or online through an application store. In the case of online distribution, at least some of the computer program products may be temporarily stored or temporarily generated in a storage medium such as a memory of a manufacturer server, an application store server, or a relay server.

Each of the components, for example, a module or a program, according to an embodiment of the present invention may be configured as a single sub-component or a plurality of sub-components, and some of the sub-components may be omitted, or other sub-components may be further included. Some components (modules or programs) may be integrated into a single entity to perform the same or similar functions performed by each corresponding component before the integration. Operations performed by the modules, programs, or other components according to an embodiment of the present invention may be executed sequentially, in parallel, repetitively, or heuristically, or at least some of the operations may be executed in a different order or omitted, or other operations may be added.

The description of the present invention described above is for illustrative purposes, and those skilled in the art may understand that it can be easily modified into other specific forms without changing the technical spirit or essential features of the present invention. Therefore, it should be understood that the embodiments described above are illustrative in all respects and not restrictive. For example, each component described as a single type may be implemented in a distributed form, and components described as distributed may also be implemented in a combined form likewise.

The scope of the present invention is indicated by the following claims, and all changes or modifications derived from the meaning and scope of the claims and their equivalents should be construed as being included in the scope of the present invention.

### DESCRIPTION OF SYMBOLS

100: College matching system
110: User interface providing unit
120: Account management unit
130: College admission basic data receiving unit
140: Acceptance rate calculation engine
150: Acceptance rate hierarchy generation unit
160: Sub-data matching unit
170: Data processing unit
180: Acceptance rate calculation parameter generation unit
190: Hierarchical acceptance rate data output unit

What is claimed is:

1. A college matching system comprising:
a user interface for inputting college admission basic data of a user;
a college admission basic data receiving unit for receiving and storing the input college admission basic data of the user;
an acceptance rate calculation parameter generation unit for generating an acceptance rate calculation parameter to be applied to an acceptance rate calculation algorithm of each college based on a first basic data corresponding to acceptance statistics of each college and a second basic data corresponding to data on successful applicants of each college;
an acceptance rate calculation engine for calculating an acceptance rate by applying a weight to the college admission basic data and using the acceptance rate calculation algorithm to which the generated acceptance rate calculation parameter and the weight is applied;
an acceptance rate hierarchy generation unit for classifying the calculated acceptance rate into a hierarchy according to a preset condition; and
a hierarchical acceptance rate data output unit for providing data on the acceptance rate classified into a hierarchy and information on colleges corresponding thereto.

2. The system according to claim 1, wherein the acceptance rate calculation engine includes:
a college admission basic data analysis unit for analyzing the college admission basic data of the user;
an acceptance rate calculation parameter search unit for searching for the acceptance rate calculation parameter based on the analyzed college admission basic data of the user;
a user information weight application unit for assigning a weight according to a predetermined condition to the college admission basic data of the user;
a rank information application unit for applying rank information of the college to the acceptance rate calculation parameter based on the first basic data; and
an acceptance rate calculation unit for calculating the acceptance rate by setting the weighted college admission basic data as a variable and setting the acceptance rate calculation parameter as a coefficient in the acceptance rate calculation algorithm.

3. The system according to claim 1, further comprising a data processing unit for extracting and processing only necessary data from the first basic data and the second basic data, wherein the data processing unit extracts and processes at least one among a college ID, a GPA score, A SAT/ACT distribution, an acceptance rate, and a rank from the first basic data, and extracts and processes at least one among a college ID, a GPA score, a SAT/ACT score, a major, and an extracurricular activity from the second basic data.

4. The system according to claim 3, wherein the data processing unit supplements the first basic data using the second basic data.

5. The system according to claim 4, further comprising a sub-data matching unit for matching sub-data to the acceptance rate calculated based on the college ID of the first basic data.

6. The system according to claim 1, further comprising a hierarchical acceptance rate data output unit for outputting at least one piece of information for each of a reach school, a target school, and a safety school according to the acceptance rate classified into a hierarchy.

7. A method of matching a college based on a hierarchical acceptance rate by a college matching system connected to a user terminal through a network, the method comprising the steps of:
a) securing college admission basic data of a user by providing an input interface to the user terminal, by the college matching system;
b) analyzing the college admission basic data of the user, by the college matching system;
c) searching for an acceptance rate calculation parameter based on the analyzed college admission basic data of the user, by the college matching system;
d) applying a weight to the college admission basic data of the user, by the college matching system;
e) calculating an acceptance rate using the acceptance rate calculation parameter and an acceptance rate calculation algorithm to which the weighted college admission basic data is applied, by the college matching system; and
f) classifying the calculated acceptance rate into a hierarchy according to a preset condition, and outputting the acceptance rate together with a matching college, wherein the acceptance rate calculation parameter is generated based on a first basic data corresponding to acceptance statistics of each college and a second basic data corresponding to data on successful applicants of each college.

8. The method according to claim 7, wherein the acceptance rate calculation parameter is generated by supplementing the first basic data using the second basic data.

9. The method according to claim 8, wherein the college admission basic data of the user includes at least one among a grade level, a region of school, a major, a tuition fee, a SAT/ACT score, and a GPA score.

10. The method according to claim 7, wherein step f) includes the step of outputting at least one piece of information for each of a reach school, a target school, and a safety school according to the acceptance rate classified into a hierarchy.

11. The method according to claim 10, further comprising the step of displaying at least one additional college for each of the reach school, the target school, and the safety school in descending order or ascending order of the acceptance rate.
